(19) United States
(12) Patent Application Publication
(10) Pub. No.: US 2023/0337034 A1
(43) Pub. Date: Oct. 19, 2023

(54) CONCURRENT MEASUREMENT GAPS FOR MULTIPLE RADIO ACCESS TECHNOLOGIES (RATS)

(71) Applicant: Apple Inc., Cupertino, CA (US)

(72) Inventors: Qiming Li, Beijing (CN); Dawei Zhang, Saratoga, CA (US); Haijing Hu, Los Gatos, CA (US); Jie Cui, San Jose, CA (US); Manasa Raghavan, Sunnyvale, CA (US); Xiang Chen, Campbell, CA (US); Yuqin Chen, Beijing (CN)

(73) Assignee: Apple Inc., Cupertino, CA (US)

(21) Appl. No.: 18/134,491

(22) Filed: Apr. 13, 2023

Related U.S. Application Data
(60) Provisional application No. 63/331,585, filed on Apr. 15, 2022.

(51) Int. Cl. H04W 24/10; H04W 8/22

(52) U.S. Cl. CPC H04W 24/10; H04W 8/22

(57) ABSTRACT

The present application relates to devices and components including apparatus, systems, and methods to perform measurements on reference signals based on concurrent measurement gaps. In an example, a device supports concurrent measurement gaps for intra-RAT measurements. The device can also indicate to a network whether it supports concurrent measurement gaps for inter-RAT measurements. Based on this indication, the network can configure measurement gap patterns and measurement objects for the UE to perform intra-RAT measurements and, as applicable, inter-RAT measurements.

### CROSS REFERENCE TO RELATED APPLICATION

This application claims the benefit of U.S. Provisional Pat. Application No. 63/331,585, filed on Apr. 15, 2022, which is herein incorporated by reference in its entirety for all purposes.

### BACKGROUND

Cellular communications can be defined in various standards to enable communications between a user equipment and a cellular network. For example, Fifth generation mobile network (5G) is a wireless standard that aims to improve upon data transmission speed, reliability, availability, and more.

### BRIEF DESCRIPTION OF THE DRAWINGS

FIG. 1 illustrates an example of a network environment, in accordance with some embodiments.

FIG. 2 illustrates an example of a measurement gap, in accordance with some embodiments.

FIG. 3 illustrates an example of concurrent measurement gaps, in accordance with some embodiments.

FIG. 4 illustrates an example of a sequence diagram between a user equipment (UE) and a network node associated with using measurement gap configurations, in accordance with some embodiments.

FIG. 5 illustrates an example of usage of a number of concurrent measurement gaps, in accordance with some embodiments.

FIG. 6 illustrates an example of a UE’s behavior when a measurement gap configuration is not supported by the UE, in accordance with some embodiments.

FIG. 7 illustrates another example of a UE’s behavior when a measurement gap configuration is not supported by the UE, in accordance with some embodiments.

FIG. 8 illustrates an example of an operational flow/algorithmic structure for a UE using concurrent measurement gaps, in accordance with some embodiments.

FIG. 9 illustrates an example of an operational flow/algorithmic structure for a network node for setting up concurrent measurement gaps, in accordance with some embodiments.

FIG. 10 illustrates an example of receive components, in accordance with some embodiments.

FIG. 11 illustrates an example of a UE, in accordance with some embodiments.

FIG. 12 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) can communicate with a network, such as with one or more base stations or other network nodes, using a first radio access technology (RAT), such as a 5G RAT. The UE may also support a second RAT or multiple other RATs, such as a long term evolution (LTE) RAT, a wideband code division multiple access (WCDMA) RAT, a global system for mobiles (GSM) RAT, a code division multiple access (CDMA) RAT, a WiFi RAT, etc.

When using at least the first RAT, the UE can use a measurement gap to perform measurements on reference signals (RSs) in a frequency range (e.g., any of FR1, FR2 in the case of the 5G RAT). The measurement gap can have a configuration that indicates a time duration (referred to as measurement gap length (MGL)) and a repetition period (referred to as measurement gap repetition period (MGRP)). The MGL and the MGRP can represent a measurement gap pattern. Transmission and reception of data on one or more channels in the frequency range can be stopped for the time duration of the measurement gap, such that the UE can at least retune its radio frequency (RF) circuitry and receive the reference signals during the measurement gap. Thereafter, the transmission and reception can resume. The measurement gap can be repeated according to the repetition period.

When also using at least the first RAT, the UE can support concurrent measurement gaps. The concurrent measurement gaps can represent measurement gaps that are configured using different measurement gap patterns and that are usable concurrently. For instance, a first measurement gap pattern can be used in a first frequency range, whereas a second, different measurement gap pattern can be used in a second frequency range.

When also supporting at least a second RAT, the UE can indicate to the network (e.g., to a base station thereof) its capability to support concurrent measurement gaps for inter-RAT measurement. For instance, whereas the UE supports concurrent measurement gaps for a 5G RAT, the UE can send capability information indicating whether it supports concurrent measurement gaps for other possible RATs, for each one of the other RATs (e.g., for an LTE RAT, for a WCDMA RAT, etc.), a number of concurrent measurement gaps that the UE supports for the other possible RATs, and/or a number of concurrent measurement gaps that the UE supports for each one of the other RATs (e.g., the supported number for the LTE RAT, the supported number for the WCDMA RAT, etc.). In this way, the network can determine not only the UE’s concurrent measurement gap capability with respect to the first RAT, but also its concurrent measurement gap capability with respect to the other possible RATs at a collective level (e.g., all the other possible RATs) and/or an individual level (e.g., one of the other possible RATs). The network can then configure the UE to use a particular measurement gap pattern for a second RAT. Such an approach provides flexibility to the network and the UE, while also reducing the complexity of the UE to support concurrent measurement gaps in one or more of the RATs, as further described herein below.

Embodiments of the present disclosure are described in connection with 5G networks. However, the embodiments are not limited as such and similarly apply to other types of communication networks including other types of cellular networks.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE’s access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by Third Generation Partnership Project (3GPP) standards. These accesses include, but are not limited to, GSM/GPRS, LTE, LTE-A, and/or 5G New Radio (NR). In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G Core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

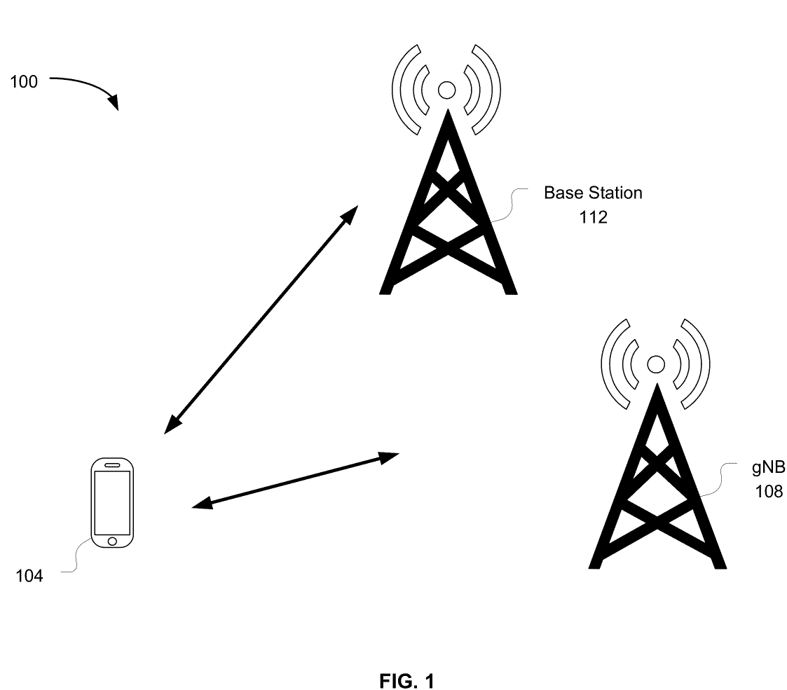

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards.

The gNB 108 may transmit information (for example, data and control signaling) in the downlink direction by mapping logical channels on the transport channels, and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure (including cell selection and reselection) and for beam selection.

The PDSCH may be used to transfer end-user application data, signaling radio bearer (SRB) messages, system information messages (other than, for example, MIB), and paging messages.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include channel status information reference signals (CSI-RS). The CSI-RS may be a multi-purpose downlink transmission that may be used for CSI reporting, beam management, connected mode mobility, radio link failure detection, beam failure detection and recovery, and fine tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, twelve resource elements. A control channel element (CCE) may represent a group of resources used to transmit PDCCH. One CCE may be mapped to a number of REGs, for example, six REGs.

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data) and can carry UCI.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

In an example, communications with the gNB 108 and/or a base station can use channels in the frequency range 1 (FR1) band, frequency range 2 (FR2) band, and/or high frequency range (FRH) band. The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

As further illustrated in FIG. 1, the network environment 100 may further include a base station 112 with which the UE 104 may also connect. The base station 112 supports the same RAT as the gNB 108 (e.g., the base station 112 is also a gNB). Additionally or alternatively, the base station 112 supports a different RAT (e.g., an LTE eNB).

In an example, the UE 104 supports carrier aggregation (CA), whereby the UE 104 can connect and exchange data simultaneously over multiple component carriers (CCs) with the gNB 108 and/or the base station 112. The CCs can belong to the same frequency band, in which case they are referred to as intra-band CCs. Intra-band CCs can be contiguous or non-contiguous. The CCs can also belong to different frequency bands, in which case they are referred to as inter-band CCs. A serving cell can be configured for the UE 104 to use a CC. A serving cell can be a primary (PCell), a primary secondary cell (PSCell), or a secondary cell (SCell). Multiple SCells can be activated via an SCell activation procedures where the component carriers of these serving cells can be intra-band contiguous, intra-band noon-contiguous, or inter-band. The serving cells can be collocated or non-collocated.

The UE 104 can also support dual connectivity (DC), where it can simultaneously transmit and receive data on multiple CCs from two serving nodes or cell groups (a master node (MN) and a secondary node (SN)). DC capability can be used with two serving nodes operating in the same RAT or in different RATs (e.g., an MN operating in NR, while an SN operates in LTE). These different DC modes include, for instance, evolved-universal terrestrial radio access-new radio (EN)-DC, NR-DC, and NE-DC (the MN is a NR gNB and the SN is an LTE eNB).

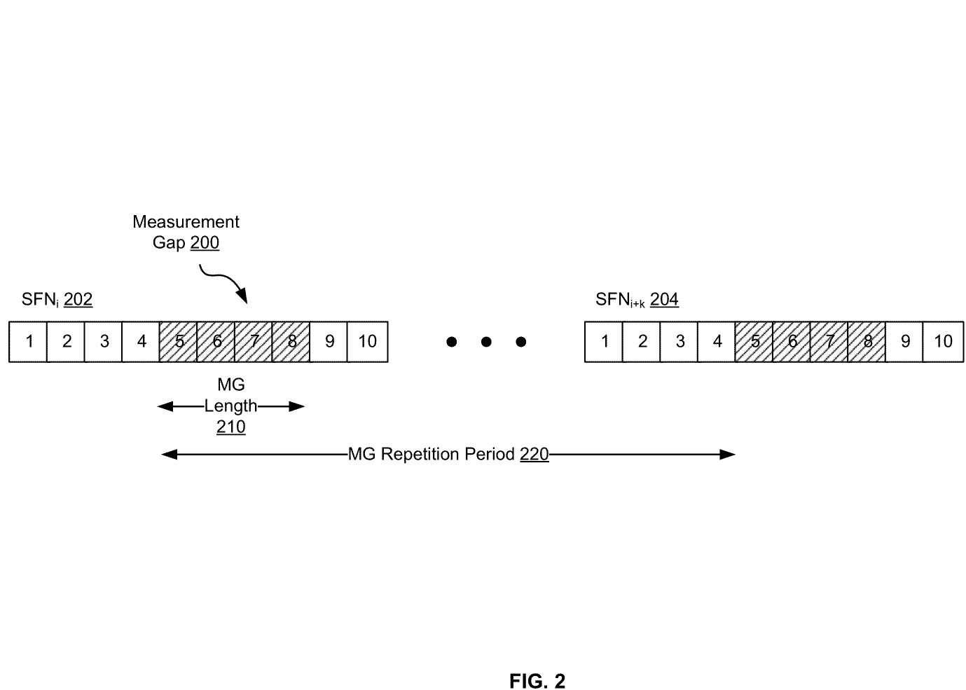

FIG. 2 illustrates an example of a measurement gap 200, in accordance with some embodiments. Generally, a UE, such as the UE 104 of FIG. 1, needs to measure reference signals (e.g., SSBs, CRI-Rs, etc.) on neighboring cell signals and other component carriers using its RF circuitry. Such measurements can impact data transmission and/or reception with a serving cell, where such data transmission and/or reception relies on the RF circuitry. For inter-frequency and/or other RAT reference signal measurements, the UE stops the data transmission and/or reception and retunes its RF circuitry to configured frequencies (e.g., according to configured measurement object(s)). After the measurements, the UE can again retune its RF circuity to then resume the data transmission and/or reception with the serving cell. A time duration for both retuning and during which the reference signals can be received and the data transmission and/or reception stopped can be defined as the measurement gap 200.

A measurement gap configuration can be defined for the measurement gap 200 and signaled from the network to the UE. As illustrated in FIG. 2, the measurement gap configuration includes a measurement gap length 210 and a measurement repetition period 220, although additional measurement gap parameters are possible. The measurement gap length 210 can represent the length of measurement gap. This length can be a time duration expressed in milliseconds (or some other unit). The measurement gap repetition period 220 can represent the periodicity (e.g., in milliseconds or some other unit) at which the measurement gap 200 repeats. The measurement gap length 210 and the measurement repetition period 220 can jointly represent a measurement gap pattern. The network can refer to the measurement gap pattern with a measurement gap pattern index. Other measurement gap parameters include, for instance, a measurement gap timing advance, which can represent a time duration by which the UE advances the start of the measurement gap (e.g., by moving ahead the start of the RF circuit retuning). As further described herein below, in the case of concurrent measurement gaps, other measurement parameter can include the number of concurrent measurement gaps that a UE can support (per RAT or for a set of RATs).

As further illustrated in FIG. 2, a frame structure is shown. Generally, a radio frame is ten milliseconds long and can be referred to with a system frame number (SFN). FIG. 2 illustrates two radio frames, labeled as SFNᵢ 202 and SFNᵢ₊ₖ204, with the three dots indicating that “k-1” radio frames exist between these two radio frames. Each radio frame includes ten sub-frames, each one millisecond long, (shown with the boxes numbered “1” through “10”). Each sub-frame includes a number of slots (not shown in FIG. 2). The length of a slot and the number of slots per sub-frame can depend on the subcarrier spacing (SCS). Different SCSs are possible, depending on the frequency range. SCS of fifteen, thirty, sixty, one-hundred and twenty, and two-hundred and forty kilohertz (KHz) are supported with FR1 and FR2 and are referred to with numerology “µ” of “0,” “1,” “2,” “3,” and “4.” Additional SCSs can be supported in frequency ranges higher than FR2 including, for instance, four-hundred and eighty, nine-hundred and sixty, and one thousand nine-hundred and twenty KHz which can be referred to with numerology “µ” of “5,” “6,” and “7.” The change in the subcarrier spacing allows flexibility around the length of a slot and the number of slots within a sub-frame. For example, the higher the numerology, the shorter the slot can be. The number of symbols within a slot does not change based on the subcarrier spacing but can change depending on the slot configuration type. For slot configuration 0, the number of symbols in a slot is fourteen. In comparison, for slot configuration 1, this number is seven.

In the illustrative example of FIG. 2, the measurement gap 200 occupies four sub-frames (e.g., sub-frame “5,” “6,” “7,” and “8” shown with diagonally dashed boxes). The measurement gap 200 also repeats every “k” radio frames. In this illustration, the measurement gap length is four milliseconds (equal to four one-millisecond sub-frames). If “k” is four, the measurement gap repetition period is forty milliseconds (equal to four ten-millisecond radio frames).

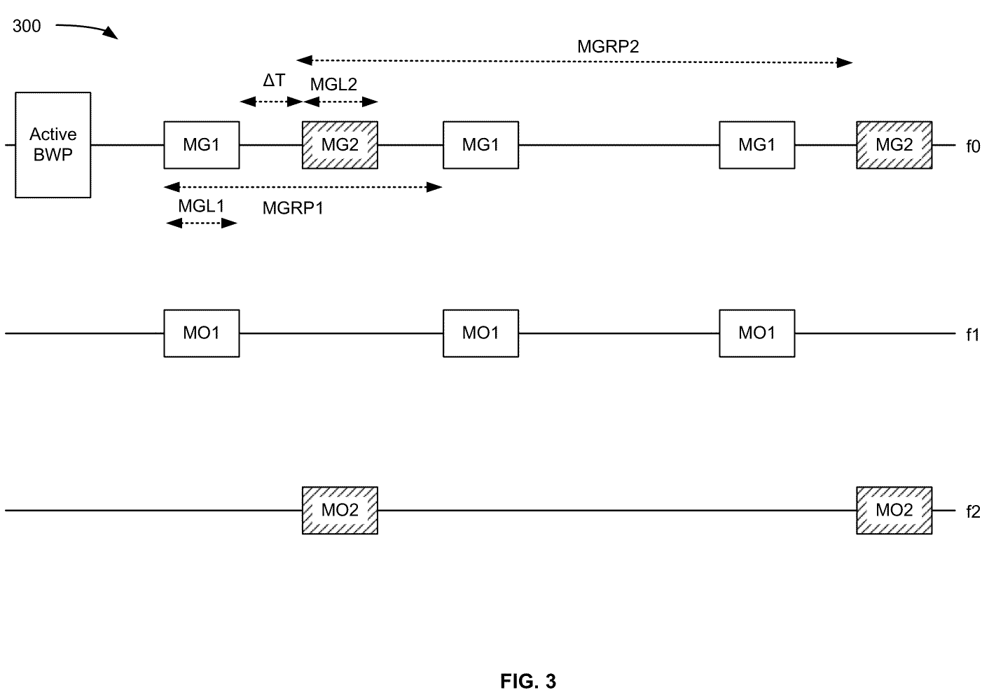

In FIG. 2, the measurement gap pattern (e.g., the measurement gap length of four milliseconds and the measurement gap repetition period of forty milliseconds) are defined for the UE in a measurement gap configuration. In certain situations, the measurement gap configuration can define multiple measurement gaps that can be used concurrently. Such measurement gaps are referred to herein as “concurrent measurement gaps.” For instance, and as further described in FIG. 3, the measurement gap pattern of FIG. 2 is a first measurement gap pattern. A second measurement gap pattern can be configured for the UE (having the same measurement gap length and measurement gap repetition period and using a different offset, or having a different measurement gap length and/or a different measurement gap repetition period). The two measurement patterns are associated with two measurement objects, respectively. The network can send reference signals to the UE. A first set of reference signals corresponds to the first measurement object and is sent according to the first measurement gap pattern. A second set of reference signals corresponds to the second measurement object and is sent according to the second measurement gap pattern. Based on the two measurement gap patterns, the UE can receive and perform measurements on the received reference signals.

In a 5G network, multiple concurrent and independent measurement gap pattems can be used (e.g., at least two). Such pattems can be subject to radio resources management (RRM) requirements. The RRM requirements can define requirements for a UE maximum number of concurrent and independent measurement pattems active at any time, requirements for multiple concurrent and independent measurement gap pattems (e.g., the specific MGLs and MGRPs), requirements and UE behavior for proximity of measurement gap instances in time, priority, and partial or full overlap of measurement gap instances, and corresponding measurement requirements. Applicability of multiple concurrent and independent gap patterns may be specified. Procedures and signaling for simultaneous RRC (re-)configuration of one or more measurement gap pattems may also be specified. Protocol impacts for multiple concurrent and independent measurement pattems may also be specified. Such requirements and specifications may be captured in different technical specifications including, for instance, 3GPP TS38.306, 3GPP TS38.133, and/or 3GPP TS38.331.

FIG. 3 illustrates an example of concurrent measurement gaps 300, in accordance with some embodiments. As illustrated, two measurement gap pattems are configured for a UE and correspond to the concurrent measurement gaps 300, although a larger number of concurrent measurement caps is possible. The first measurement gap pattern (shown in figure by using an “MG1” label) has a first measurement gap length (shown as “MGL1”) and a first measurement gap repetition period (shown as “MGRP1”). Similar, the second measurement gap pattern (shown in figure by using an “MG2” label) has a second measurement gap length (shown as “MGL2”) and a second measurement gap repetition period (shown as “MGRP2”). An offset, e.g., in the time domain (shown as “ΔT”), may exist between the two measurement gap patterns (e.g., between an instance of the ending of the first measurement gap and an instance of the beginning of the second measurement gap). The first measurement gap length can, but need not, be different from the second measurement gap length. Further, the first measurement gap repetition period can, but need not, be different from the second measurement gap repetition period.

In the illustration of FIG. 3, an active bandwidth part (BWP) configured for the UE (e.g., shown as a BWP of a frequency band “f0”) does not contain the frequency domain resources for reference signals to be measured. In this case, measurement objects (MOs) are configured for the UE on other frequency bands, such as a first measurement object on a first frequency band (shown as “MO1” on a frequency band “f1) and a second measurement object on a second frequency band (shown as “MO2” on a frequency band “f2”).

In this case, the UE can perform intra-frequency measurements outside of the active BWP. The first measurement object can be associated with the first measurement gap pattern. As such, first reference signals (e.g., SSBs and/or CSI-Rs) can be sent by the network on the first frequency band and received and measured by the UE according to the first measurement gap pattern. This is shown in FIG. 3, where the timing and time length of the first reference signals correspond to the first measurement gaps (e.g., each “MO1” corresponds, in the time domain, to a respective “MG1”). Likewise, second reference signals (e.g., SSBs and/or CSI-Rs) can be sent by the network on the second frequency band and received and measured by the UE according to the second measurement gap pattern. This is also shown in FIG. 3, where the timing and time length of the second reference signals correspond to the second measurement gaps (e.g., each “MO2” corresponds, in the time domain, to a respective “MG2”).

As such, the use of the concurrent measurement gaps 300 allows the UE to be configured with multiple measurement objects in different frequency bands (e.g., intra-RAT measurements), where the target reference signals to be measured in each measurement object are not fully overlapped in the time domain. When there is no full overlap, it may not be possible for the network to configure only one measurement gap pattern for the UE to measure all the measurement objects. Accordingly, the use of the concurrent measurement gaps 300 can enable the use of non-fully overlapping reference signals and the relevant reference signal measurements.

In FIG. 3, the support of concurrent measurement gaps can be specific to a RAT (e.g., a 5G RAT). The UE can indicate, to the network, the type of support, if any, of concurrent measurement gaps. For instance, the UE indicates whether it supports the concurrent measurement gaps in general. This type of support can be referred to as a per-UE concurrent measurement gap support. In a 5G RAT, this per-UE support can be referred to as a support of more than one per-UE measurement gap configurations. The UE can also indicate whether it supports the concurrent measurement gaps per frequency range of the RAT. This type of support can be referred to as a per-FR concurrent measurement support. In a 5G RAT, this per-FR support can also be referred to as a support of more than one per-FR measurement gap configurations in an FR, or simultaneously one per UE-measurement gap plus one per-FR measurement gap configurations in an FR, or more than one per-UE measurement gap configurations for UE capable of Rel-15 per-FR gap (independentGapConfig).

As explained herein above, the per-UE concurrent measurement gaps support for a RAT (e.g., a 5G RAT) or per-FR concurrent measurement gaps support for the RAT can be indicated to the network that supports the RAT. Doing so can enable intra-RAT measurements of reference signals using different measurement gap patterns in the RAT. However, challenges can exist when the UE and/or the network support multiple RATs (e.g., in addition to the 5G Rat, an LTW RAT, a WCDMA RAT, etc.).

In particular, supporting the concurrent measurement gaps for the first RAT does not mean that the UE is capable of supporting the concurrent measurement gaps for a second RAT. For instance, the UE can support concurrent measurement gaps for intra-RAT measurements (e.g., inter-frequency measurements in the first RAT) but not for inter-RAT measurement (e.g., measurements of reference signals received in a second RAT).

One approach may involve using different RAT modules (e.g., a module for 5G, a module for LTE, etc.) to perform measurements toward the different RATs. With this approach, there may be restrictions that concurrent measurement gaps could only be supported by a NR (e.g., 5G) module. The support can imply a software (or even hardware, such as memory) update. As NR deployment is becoming broader and broader, UE vendors may have less interest in upgrading UE legacy RAT modules (e.g., electronic universal mobile telecommunications system (E-UTRAN), universal terrestrial radio access network (UTRAN), GSM and so on). As such, given the restrictions, this approach may necessitate a UE to report its concurrent measurement gaps support only if the UE provides such support for all the RATs (e.g., the UE has been updated or designed with such support). In other words, if the UE supports the concurrent measurement gaps for both the first RAT and the second RAT (and, as applicable, for all such second RATs), the UE can indicate to the network its support for concurrent measurement gaps. However, if the UE does not support the concurrent measurement gaps for at least the second RAT, the UE cannot indicate its support for the concurrent measurement gaps even through the UE is capable of doing so for at least the first RAT. Such an approach can suffer from multiple drawbacks. For instance, this approach is not flexible enough and can prevent the use of concurrent measurement gaps in the first RAT even when the UE would have been able to do so in the first RAT. This approach may also necessitate an update to the UE across the different RAT modules (e.g., software and/or hardware as applicable) in order to support the concurrent measurement gaps.

Another approach is further described in connection with the next figures. Briefly, this approach enables the UE to indicate its capability of supporting concurrent measurement gaps for inter-RAT measurements. This capability can be indicated at a general level of multiple second RATs, at an individual level of each second RAT, and/or at a measurement gap pattern level (e.g., the number of measurement gap pattems that the UE supports at the general level and/or the individual level).

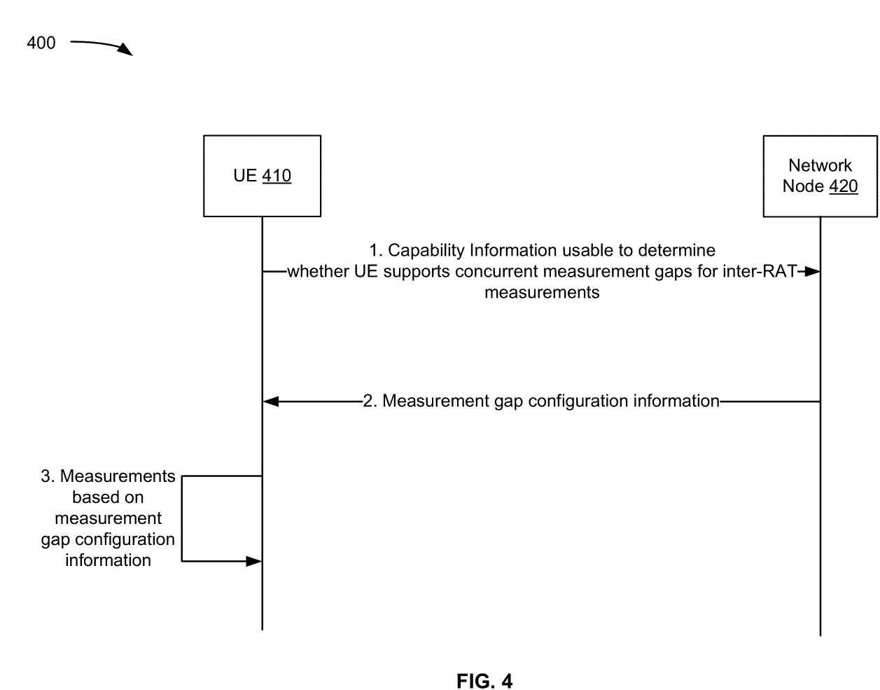

FIG. 4 illustrates an example of a sequence diagram 400 between UE 410 and a network node 420 associated with using measurement gap configurations, in accordance with some embodiments. The UE 410 is an example of the UE 104. The network node 420 can be a base station, such as the gNB 108, or can be any node that provides the UE 410 with access to a network (e.g., a 5G cellular network). Generally, at the time of registration and before the UE 410 can exchange traffic data with the network node 420, the network node 420 may send an enquiry about the UE capability to the UE 410 (e.g., a UECapabilityEnquiry), and the UE 410 may send back UE capability information to the network node 420 (e.g., UECapabilityInformation). The UE capability information can indicate the UE’s 410 support of concurrent measurement gaps. Thereafter (e.g., during a UE attached and after a radio bearer is set up), the network node 420 can send a measurement gap configuration to the UE 410 indicating, as applicable, concurrent measurement gaps to be used. Additionally, or alternatively, the network node 420 can request the UE 410 to send its capabilities at any time during an RRC connected state and the UE can respond indicating its UE capability information by using RRC signaling.

In an example, the sequence diagram 400 includes the UE 410 sending capability information to the network node 420, where this capability information is usable to determine whether the UE supports concurrent measurement gaps for inter-RAT measurements. This capability information can also indicate whether the UE supports concurrent measurement gaps for intra-RAT measurements. Optionally, to be able to support concurrent measurement gaps for inter-RAT measurements, the UE may need to support concurrent measurement gaps for intra-RAT measurements. When this option is used, if the UE 410 reports its support for the inter-RAT measurements, the UE 410 may need not to indicate separately its support for the intra-RAT measurements because such a support can be implicitly determined. Alternatively, even if the UE 410 reports its support for the inter-RAT measurements, the UE 410 may indicate separately its support for the intra-RAT measurements.

Generally, intra-RAT measurements are measurement in a first RAT (e.g., a 5G RAT), whereas inter-RAT measurements are measurements in one or more second RATs other than the first RAT. The concurrent measurement gaps support for intra-RAT measurements can be indicated by including in the reported UE capability information an index specific to the concurrent measurement gaps support (per-UE and/or per-FR) in the first RAT. In the case of an implicit determination of the intra-RAT support, such an indication may optionally not be used, and, if this indication is not used, the support can be assumed if the UE 410 indicates that it supports concurrent measurement gaps for inter-RAT measurements. Different approaches are possible to indicate the UE support of concurrent measurement gaps for inter-RAT measurements.

In a first example approach, the UE capability information is at the general level of the second RATs (e.g., applicable to all such second RATs). For instance, the UE capability information includes an index pre-defined as indicating the concurrent measurement gaps support (per-UE and/or per-FR) across the second RATs. In this approach, a first index (e.g., 19-2) can be used to indicate the UE’s 410 support of using concurrent measurement gaps for the first RAT measurements. Further, a second index (e.g., 19-2-x1) can be used to indicate the UE’s 410 support of using concurrent measurement gaps for the inter-RAT measurements, including all the second RATs which are supported by the UE (e.g., evolved universal mobile telecommunications system (E-UTRAN), universal mobile telecommunication system (UMTS) terrestrial radio access network (UTRAN), GSM, etc.). Here, E-UTRAN, UTRAN, and GSM are provided as examples, but other RATs (e.g., WiFi) can be additionally or alternatively used. This approach can be defined in a technical specification (e.g., 3GPP TS38.306, 3GPP TS38.133, and/or 3GPP TS38.331) by associating the second index with the concurrent measurement gaps support. An example of this association can be defined in a table format, as shown in Table 1 below.

TABLE 1

| | | |
|---|---|---|
| Index | Feature group | Components |
| 19-2-x1 | Concurrent measurement gaps | • Support of more than 1 per-UE measurement gap configurations for inter-RAT measurement |
| | | • Support of more than 1 per-FR measurement gap configurations in an FR, or simultaneously 1 per UE-measurement gap plus 1 per-FR measurement gap configurations in an FR, or more than 1per-UE measurement gap configurations for UE capable of Rel-15 per -FR gap (independentGapConfig), for inter-RAT measurement |
| | | Note: the above 2 bullets are not 2 separate indications by a single indication with different interpretations, depending on the support of independentGapConfig. |

In a second example approach, the UE capability information is at the RAT level (e.g., specific to each second RAT). In other words, the UE capability information indicates, per second RAT, the UE capability for supporting concurrent measurement gaps for inter-RAT measurements. For instance, the UE capability information includes an index pre-defined per RAT as indicating the concurrent measurement gaps support for the RAT. In this approach, a first index (e.g., 19-2) can be used to indicate the UE’s 410 support of using concurrent measurement gaps for the first RAT measurements. Further, a second set of indices can be associated with the support for each second RAT. For instance, the second set includes a first index (e.g., 19-2-y 1) that indicates the UE’s 410 support of using concurrent measurement gaps for the inter-RAT E-UTRAN measurements, a second index (e.g., 19-2-y2) that indicates the UE’s 410 support of using concurrent measurement gaps for the inter-RAT UTRAN measurements, a third index (e.g., 19-2-y3) that indicates the UE’s 410 support of using concurrent measurement gaps for the inter-RAT GSM measurements, and so on. This approach can be defined in a technical specification (e.g., 3GPP TS38.306, 3GPP TS38.133, and/or 3GPP TS38.331) by associating the second set of indices with the concurrent measurement gaps support for inter-RAT measurements. An example of this association can be defined in a table format, as shown in Table 2 below.

TABLE 2

| | | |
|---|---|---|
| Index | Feature group | Components |
| 19-2-y1 | Concurrent measurement gaps | • Support of more than 1 per-UE measurement gap configurations for inter-RAT E-UTRAN measurement |
| | | • Support of more than 1 per-FR measurement gap configurations in an FR, or simultaneously 1 per UE-measurement gap plus 1 per-FR measurement gap configurations in an FR, or more than 1per-UE measurement gap configurations for UE capable of Rel-15 per -FR gap (independentGapConfig), for inter-RAT E-UTRAN measurement |
| | | Note: the above 2 bullets are not 2 separate indications by a single indication with different interpretations, depending on the support of independentGapConfig. |
| 19-2-y2 | Concurrent measurement gaps | • Support of more than 1 per-UE measurement gap configurations for inter-RAT UTRAN measurement |
| | | • Support of more than 1 per-FR measurement gap configurations in an FR, or simultaneously 1 per UE-measurement gap plus 1 per-FR measurement gap configurations in an FR, or more than 1per-UE measurement gap configurations for UE capable of Rel-15 per -FR gap (independentGapConfig), for inter-RAT UTRAN measurement |
| | | • Note: the above 2 bullets are not 2 separate indications by a single indication with different interpretations, depending on the support of independentGapConfig. |
| 19-2-y3 | Concurrent measurement gaps | • Support of more than 1 per-UE measurement gap configurations for inter-RAT GSM measurement |
| | | • Support of more than 1 per-FR measurement gap configurations in an FR, or simultaneously 1 per UE-measurement gap plus 1 per-FR measurement gap configurations in an FR, or more than 1per-UE measurement gap configurations for UE capable of Rel-15 per -FR gap (independentGapConfig), for inter-RAT GSM measurement |
| | | • Note: the above 2 bullets are not 2 separate indications by a single indication with different interpretations, depending on the support of independentGapConfig. |

In a third example approach, the UE capability information is at the general level of the second RATs (e.g., applicable to all the second RATs), while also being at the measurement gap pattern level. For instance, the UE capability information includes an index pre-defined as indicating the concurrent measurement gaps support (per-UE and/or per-FR) across the second RATs. This index is also associated with the number of concurrent measurement gap pattems that the UE supports for the inter-RAT measurements. In other words, this number is applicable to all the second RATs. In an example, a general bit is introduced to indicate the support of the number of concurrent gap patterns for inter-RAT measurement. This number can be from an enumerated range (e.g., ENUMERATED {1, 2, 3,..., n}). A measurement gap parameter (e.g., a NumberOfConcurrentGapsForInter-RAT parameter) can also be used by the UE 410 to indicate the specific value of the number (e.g., assuming that the enumerated range is ENUMERATED {1, 2, 3,..., n}, the measurement gap parameter can indicate that the UE 410 actually supports “2” measurement gap patterns out of the “n” possible measurement gap patterns for the inter-RAT measurements). This approach can be defined in a technical specification (e.g., 3GPP TS38.306, 3GPP TS38.133, and/or 3GPP TS38.331) by associating the index with the concurrent measurement gaps support. An example of this association can be defined in a table format, as shown in Table 3 below.

TABLE 3

| | | |
|---|---|---|
| Index | Feature group | Components |
| 19-2-y | Concurrent measurement gaps | Support of number of concurrent gap patterns for inter-RAT measurement |

In a fourth example approach, the UE capability information is at the RAT level (e.g., specific to each second RAT) and the gap pattern level. In other words, the UE capability information indicates, per second RAT, the UE capability for supporting concurrent measurement gaps for inter-RAT measurements and the number of measurement gap patterns that the UE support for this second RAT. For instance, the UE capability information includes an index pre-defined per second RAT as indicating the concurrent measurement gaps support for the second RAT. This index is also associated with the number of concurrent measurement gap patterns that the UE supports for the second RAT. In an example, a bit can be introduced per second RAT to indicate the support of the number of concurrent gap patterns for inter-RAT measurement of that second RAT. This number can be from an enumerated range (e.g., ENUMERATED {1, 2, 3,..., n}). A measurement gap parameter (e.g., a NumberOfConcurrentGapsForInter-RAT parameter) can also be used by the UE 410 to indicate the specific value of the number (e.g., assuming that the enumerated range is ENUMERATED {1, 2, 3,..., n}, the measurement gap parameter can indicate that the UE 410 actually supports “2” measurement gap patterns out of the “n” possible measurement gap patterns for the inter-RAT E-UTRAN measurements and “4” measurement gap patterns out of the “n” possible measurement gap patterns for the inter-RAT UTRAN measurements). In this approach, a first index (e.g., 19-2) can be used to indicate the UE’s 410 support of using concurrent measurement gaps for the first RAT measurements. Further, a second set of indices can be associated with the support of a number of concurrent measurement gap patterns per second RAT. For instance, the second set includes a first index (e.g., 19-2-z1) that indicates the UE’s 410 support of a number of concurrent measurement gap patterns for the inter-RAT E-UTRAN measurements, a second index (e.g., 19-2-z2) that indicates the UE’s 410 support of a number of concurrent measurement gap patterns for the inter-RAT UTRAN measurements, a third index (e.g., 19-2-z3) that indicates the UE’s 410 support of a number of concurrent measurement gap patterns for the inter-RAT GSM measurements, and so on. This approach can be defined in a technical specification (e.g., 3GPP TS38.306, 3GPP TS38.133, and/or 3GPP TS38.331) by associating the second set of indices with the numbers of concurrent measurement gap patterns for inter-RAT measurements. An example of this association can be defined in a table format, as shown in Table 4 below.

TABLE 4

| | | |
|---|---|---|
| Index | Feature group | Components |
| 19-2-z1 | Concurrent measurement gaps | Support of number of concurrent gap patterns for inter-RAT E-UTRAN measurement |
| 19-2-z2 | Concurrent measurement gaps | Support of number of concurrent gap patterns for inter-RAT UTRAN measurement |
| 19-2-z3 | Concurrent measurement gaps | Support of number of concurrent gap patterns for inter-RAT GSM measurement |

In an example, the sequence diagram 400 also includes the network node 420 sending to the UE 410 information about one or more concurrent measurement gap configurations based on the capability information. For instance, this information can be sent via RRC signaling. Generally, the measurement gap configuration information indicates the measurement gap patterns (and, as needed, time offsets, timing advance, and/or other measurement gap parameters) that the UE is to use and can associate each of the measurement gap patterns with intra-RAT measurements, inter-RAT measurements, and/or specific RATs.

In an example, the sequence diagram 400 also includes the UE 410 performing measurements on reference signals based on the measurement gap configuration information. For instance, for intra-RAT measurements, the UE 410 determines the time domain information of the reference signals per the applicable set of concurrent measurement gap configurations for the first RAT to then receive and perform the relevant reference signal measurements. Similarly, for inter-RAT measurements, the UE 410 determines the time domain information of the reference signals to measure per the applicable set of concurrent measurement gap configurations for the inter-RAT measurements to then receive and perform the relevant reference signal measurements.

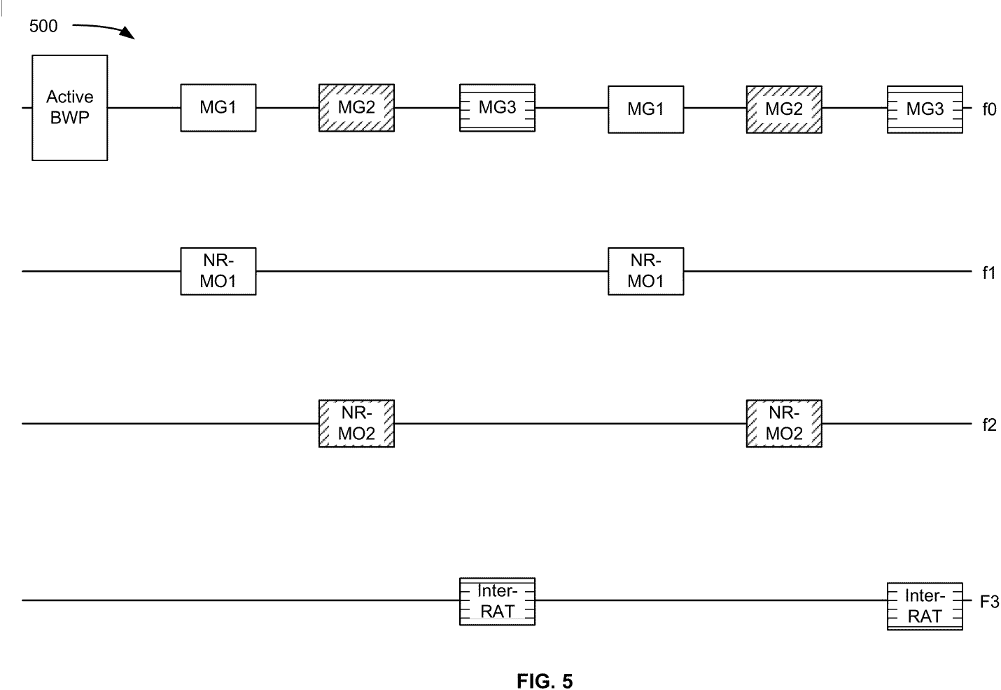

FIG. 5 illustrates an example of usage 500 of a number of concurrent measurement gaps, in accordance with some embodiments. This usage 500 can be implemented based on the third example approach and/or the fourth example approach described herein above. In the illustration of FIG. 5, “f0,” “f1,” and “f2” are frequency bands of a first RAT (e.g., a 5G RAT), whereas “F3” is a frequency band (or frequency range) of a second RAT. A UE can indicate its support of two concurrent measurement gap patterns for the first RAT and its support of one measurement gap pattern for inter-RAT measurements. Accordingly, the network configures three measurement gap patterns for the UE: the first two measurement gap patterns (shown with the first repetition of “MG1” and the second repetition of “MG2”) for the first RAT and the third measurement gap pattern (shown with the third repetition of “MG3”) for the second RAT.

The UE can perform intra-frequency measurements outside of the active BWP. In particular, the network can configure a first measurement object for the UE on the first frequency band (e.g., “f1”), where the first measurement object is associated with the first measurement gap pattern to be used for the first RAT. The network can also configure a second measurement object for the UE on the second frequency band (e.g., “f2”), where the second measurement object is associated with the first measurement gap pattern to be used for the first RAT. Additionally, the network can configure a third measurement object for the UE on the third frequency band (e.g., “f3”), where the third measurement object is associated with the third measurement gap pattern to be used for the inter-RAT measurement.

As such, first reference signals can be sent by the network on the first frequency band and received and measured by the UE according to the first measurement gap pattern. This is shown in FIG. 5, where the timing and time length of the first reference signals correspond to the first measurement gaps (e.g., each “NR-MO1” corresponds, in the time domain, to a respective “MG1”). Likewise, second reference signals can be sent by the network on the second frequency band and received and measured by the UE according to the second measurement gap pattern. This is also shown in FIG. 5, where the timing and time length of the second reference signals correspond to the second measurement gaps (e.g., each “NR-MO2” corresponds, in the time domain, to a respective “MG2”). Additionally, third reference can be sent by the network on the third frequency band and received and measured by the UE according to the third measurement gap pattern. This is also shown in FIG. 5, where the timing and time length of the third reference signals correspond to the third measurement gaps (e.g., each “inter-RAT MO” corresponds, in the time domain, to a respective “MG3”).

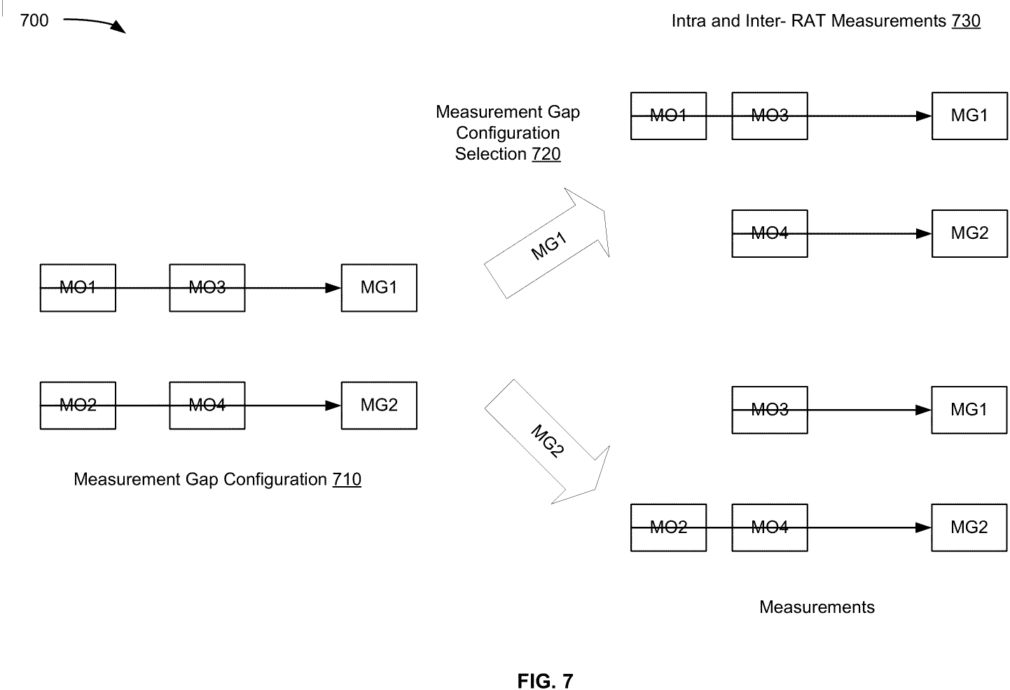

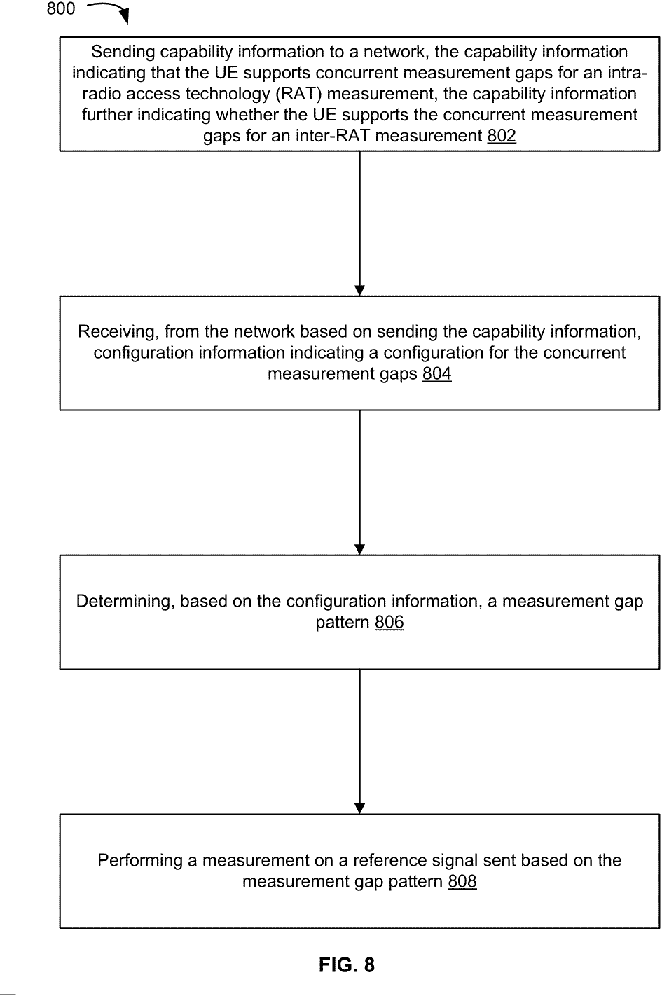

Generally, a network configures measurement objects and concurrent measurement gaps for a UE depending on the UE capability, which can be indicated to the network as described herein above. The network is expected to send reference signals based on the configured measurement objects and the configured concurrent measurement gaps. And the UE is expected to receive and measure the reference signals based on the configured measurement objects and the configured concurrent measurement gaps. However, in certain situations, the network may configure concurrent measurement gaps that the UE may not support. In these situations, the UE can be configured to determine how to perform inter-RAT measurements. For instance, the UE can select a set of measurement gap patterns that the UE is capable of support for the inter-RAT measurements and perform all inter-RAT measurement using the set of measurement gap patterns, even though some of the reference signals correspond to measurement objects that are associated with a measurement gap pattern that is not included in the set. An example of this UE behavior is shown in FIG. 7. In another illustration, the set of measurement gap patterns is used to perform only inter-RAT measurements on reference signals that are associated with such pattem(s) and can ignore measurement objects that are not associated with the set (and thus not perform measurements on reference signals that correspond to the ignored measurement objects). An example of this UE behavior is shown in FIG. 8.

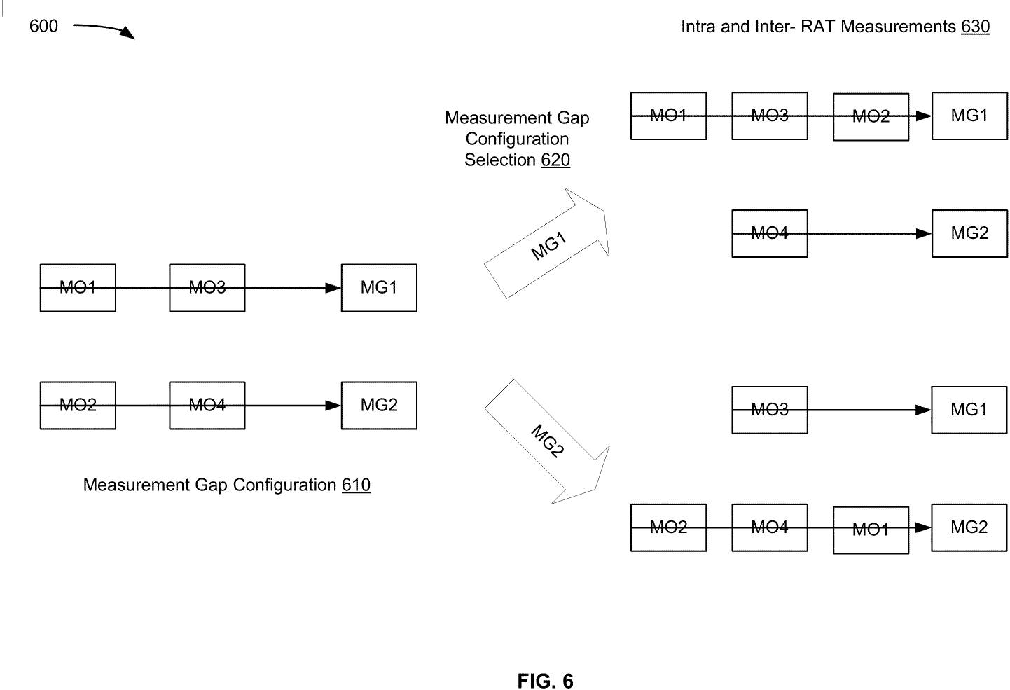

FIG. 6 illustrates an example of a UE’s behavior 600 when a measurement gap configuration is not supported by the UE, in accordance with some embodiments. In the interest of clarity of explanation, an example of two concurrent measurement gaps, intra-RAT 5G measurements, and inter-RAT E-UTRAN measurements is described. However, the embodiments of the present disclosure are not limited as such and apply to a different number of concurrent measurement gaps and/or different RATs.

In the illustrated example, the UE has indicated its support for concurrent measurement gaps for intra-RAT 5G measurement. The UE has also indicated that one measurement gap pattern is supported for inter-RAT E-UTRAN measurements (e.g., referring back to FIG. 4, this report can include “19-2-z=1”). The network sets up a measurement gap configuration 610 for the UE, where this configuration 610 associates two measurement objects for the 5G RAT (shown as “MO3” and “MO4” in FIG. 6) with two concurrent measurement patterns (shown as “MG1” and MG2” in FIG. 6). The measurement gap configuration 610 also associates two measurement objects for the E-UTRAN RAT (shown as “MO1” and “MO2” in FIG. 6) with the same two concurrent measurement patterns. The associations are shown with a first arrow connecting “MO1” and “MO3” with “MG1” and a second arrow connecting “MO2” and “MO4” with “MG2.” However, the measurement gap configuration 610 for the inter-RAT E-UTRAN measurements exceeds the UE capability.

The UE behavior 600 involves the UE performing a measurement gap configuration selection 620. For instance, the UE can select the first measurement gap pattern (as shown with the upward arrow labeled “MG1”) or the second measurement gap pattern (as shown with the downward arrow labeled “MG2”). Based on the selection, the UE performs intra and inter-RAT measurements 630.

If the first measurement gap pattern is selected, the UE performs all inter-RAT E-UTRAN measurements based on the first measurement gap pattern. The UE also measures all intra-RAT 5G measurements based on the first measurement gap pattern and the second measurement gap pattern. These measurements 630 are illustrated in the top right-hand side of FIG. 6. In particular, for the inter-RAT E-UTRAN measurements, first reference signals corresponding to the first measurement object (“MO1”) are measured based on the first measurement gap pattern, and second reference signals corresponding to the second measurement (“MO2”) are also measured based on the first measurement gap pattern rather than the second measurement gap pattern. In comparison, for the intra-RAT 5G measurements, third reference signals corresponding to the third measurement object (“MO3”) are measured based on the first measurement gap pattern, and fourth reference signals corresponding to the fourth measurement (“MO4”) are also measured based on the second measurement gap pattern.

Conversely, if the second measurement gap pattern is selected, the UE performs all inter-RAT E-UTRAN measurements based on the second measurement gap pattern. These measurements 630 are illustrated in the bottom right-hand side of FIG. 6. In particular, for the inter-RAT E-UTRAN measurements, the first reference signals corresponding to the first measurement object (“MO1”) are measured based on the second measurement gap pattern (rather than the second measurement gap pattern) and the second reference signals corresponding to the second measurement (“MO2”) are also measured based on the second measurement gap pattern. In comparison, for the intra-RAT 5G measurements, the third reference signals corresponding to the third measurement object (“MO3”) are measured based on the first measurement gap pattern, and the fourth reference signals corresponding to the fourth measurement (“MO4”) are also measured based on the second measurement gap pattern.

In this approach, RRM requirements associated with the first measurement gap pattern and the second measurement gap pattern do not apply to the UE behavior 600. For instance, the RRM requirements can be relaxed to allow additional time for the UE to perform the measurements. As such, longer latency can be expected on both the intra-RAT 5G measurements and the inter-RAT E-UTRAN measurements.

FIG. 7 illustrates another example of a UE’s behavior when a measurement gap configuration is not supported by the UE, in accordance with some embodiments. Here also, in the interest of clarity of explanation, an example of two concurrent measurement gaps, intra-RAT 5G measurements, and inter-RAT E-UTRAN measurements is described. However, the embodiments of the present disclosure are not limited as such and apply to a different number of concurrent measurement gaps and/or different RATs.

In the illustrated example, the UE has indicated its support for concurrent measurement gaps for intra-RAT 5G measurement. The UE has also indicated that one measurement gap pattern is supported for inter-RAT E-UTRAN measurements (e.g., referring back to FIG. 4, this report can include “19-2-z=1”). The network sets up a measurement gap configuration 710 for the UE, where this configuration 710 associates two measurement objects for the 5G RAT (shown as “MO3” and “MO4” in FIG. 7) with two measurement gap patterns (shown as “MG1” and MG2” in FIG. 6). The measurement gap configuration 710 also associates two measurement objects for the E-UTRAN RAT (shown as “MO1” and “MO2” in FIG. 7) with the same two concurrent measurement patterns. The associations are shown with a first arrow connecting “MO1” and “MO3” with “MG1” and a second arrow connecting “MO2” and “MO4” with “MG2.” However, the measurement gap configuration 710 for the inter-RAT E-UTRAN measurements exceeds the UE capability.

The UE behavior 700 involves the UE performing a measurement gap configuration selection 720. For instance, the UE can select the first measurement gap pattern (as shown with the upward arrow labeled “MG1”) or the second measurement gap pattern (as shown with the downward arrow labeled “MG2”). Based on the selection, the UE performs intra and inter-RAT measurements 730.

If the first measurement gap pattern is selected, the UE only performs inter-RAT E-UTRAN measurements for reference signals that are associated with the first measurement gap pattern. The UE also measures all intra-RAT 5G measurements based on the first measurement gap pattern and the second measurement gap pattern. These measurements 730 are illustrated in the top right-hand side of FIG. 7. In particular, for the inter-RAT E-UTRAN measurements, first reference signals corresponding to the first measurement object (“MO1”) are measured based on the first measurement gap pattern, whereas second reference signals corresponding to the second measurement (“MO2”) are ignored and not measured. In comparison, for the intra-RAT 5G measurements, third reference signals corresponding to the third measurement object (“MO3”) are measured based on the first measurement gap pattern, and fourth reference signals corresponding to the fourth measurement (“MO4”) are also measured based on the second measurement gap pattern.

Conversely, if the second measurement gap pattern is selected, the UE only performs inter-RAT E-UTRAN measurements for reference signals that are associated with the second measurement gap pattern. The UE also measures all intra-RAT 5G measurements based on the first measurement gap pattern and the second measurement gap pattern. These measurements 730 are illustrated in the bottom right-hand side of FIG. 7. In particular, for the inter-RAT E-UTRAN measurements, the first reference signals corresponding to the first measurement object (“MO1”) are ignored and not measured, whereas the second reference signals corresponding to the second measurement (“MO2”) are measured based on the second measurement gap pattern. In comparison, for the intra-RAT 5G measurements, the third reference signals corresponding to the third measurement object (“MO3”) are measured based on the first measurement gap pattern, and the fourth reference signals corresponding to the fourth measurement (“MO4”) are also measured based on the second measurement gap pattern.

In this approach, RRM requirements associated with the inter-RAT E-UTRAN measurements do not apply to the UE behavior 700 because the network may not know which measurement objects are ignored by the UE. However, RRM requirements associated with the intra-RAT 5G measurements still apply to the UE behavior 700.

FIG. 8 illustrates an example of an operational flow/algorithmic structure 800 for a UE using concurrent measurement gaps, in accordance with some embodiments. The UE is an example of the UE 104, 410, or any UE that includes one or more processors and one or more memory storing computer-readable instructions that, upon execution by the one or more processors, configure the UE to perform operations of the operational flow/algorithmic structure 800.

The operation flow/algorithmic structure 800 may include, at 802, sending capability information to a network, the capability information indicating that the UE supports concurrent measurement gaps for intra-RAT measurement, the capability information further indicating whether the UE supports the concurrent measurement gaps for an inter-RAT measurement. For example, the capability information can be sent in a capability report in response to a capability enquiry of a network node of the network (e.g., a gNB thereof) or can be sent in an RRC message while the UE is in an RRC connected mode. The capability information can take the form of the capability information described herein above in connection with FIG. 4.

The operation flow/algorithmic structure 800 may include, at 804, receiving, from the network based on sending the capability information, configuration information indicating a configuration for the concurrent measurement gaps. For example, if the UE supports only concurrent measurement gaps for intra-RAT measurements, the configuration information can indicate one or more measurement gap patterns to use for the intra-RAT measurements along with measurement objects. If the UE also supports concurrent measurement gaps for inter-RAT measurements, the configuration information can indicate one or more measurement gap patterns to use for the inter-RAT measurements along with measurement objects.

The operation flow/algorithmic structure 800 may include, at 806, determining, based on the configuration information, a measurement gap pattern. For example, the UE determines, from the configuration information, a measurement gap period and a measurement gap repetition period, among other parameters (e.g., timing advance) for use in association with a measurement object.

The operation flow/algorithmic structure 800 may include, at 808, performing a measurement on a reference signal sent based on the measurement gap pattern. For example, the UE determines, based on the measurement object and the measurement gap pattern, information in the time domain and frequency domain for receiving the reference signal. Given this information, the UE stops transmission/reception of data during the measurement gap and at least performs reference signal measurements. Thereafter, the UE resumes transmission/reception of data the next measurement gap occurrence.

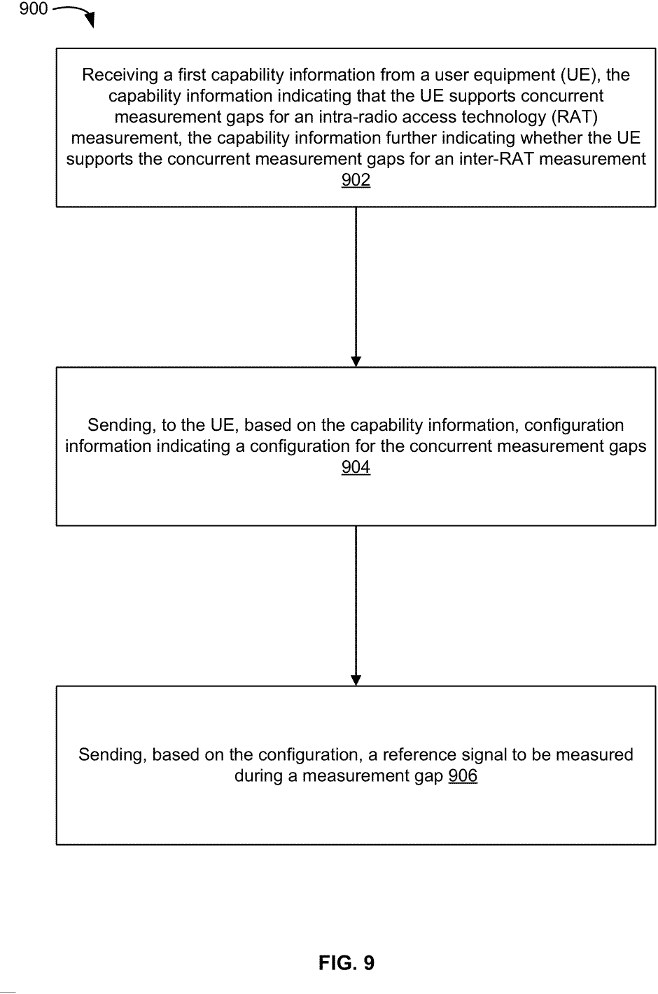

FIG. 9 illustrates an example of an operational flow/algorithmic structure 900 for a network node for setting up concurrent measurement gaps, in accordance with some embodiments. The network node is an example of the UE gNB 108, the network node 420, or any network node that includes one or more processors and one or more memory storing computer-readable instructions that, upon execution by the one or more processors, configure the network node to perform operations of the operational flow/algorithmic structure 900.

The operation flow/algorithmic structure 900 may include, at 902, receiving a first capability information from a UE, the capability information indicating that the UE supports concurrent measurement gaps for an intra-RAT measurement, the capability information further indicating whether the UE supports the concurrent measurement gaps for an inter-RAT measurement. For example, the capability information can be received in a capability report in response to a capability enquiry of the network node or can be received in an RRC message while the UE is in an RRC connected mode. The capability information can take the form of the capability information described herein above in connection with FIG. 4.

The operation flow/algorithmic structure 900 may include, at 904, sending, to the UE, based on the capability information, configuration information indicating a configuration for the concurrent measurement gaps. For example, if the capability information indicates that UE supports only concurrent measurement gaps for intra-RAT measurements, the configuration information can indicate one or more measurement gap patterns to use for the intra-RAT measurements along with measurement objects. If the capability information indicates that the UE also supports concurrent measurement gaps for inter-RAT measurements, the configuration information can indicate one or more measurement gap patterns to use for the inter-RAT measurements along with measurement objects.

The operation flow/algorithmic structure 900 may include, at 906, sending, based on the configuration, a reference signal to be measured during a measurement gap. For example, the network node also configures one or more measurement objects for the UE. Based on a configured measurement gap pattern and a measurement object, the network node sends a reference signal for the UE to measure during a measurement gap that corresponds to the configured measurement gap pattern.

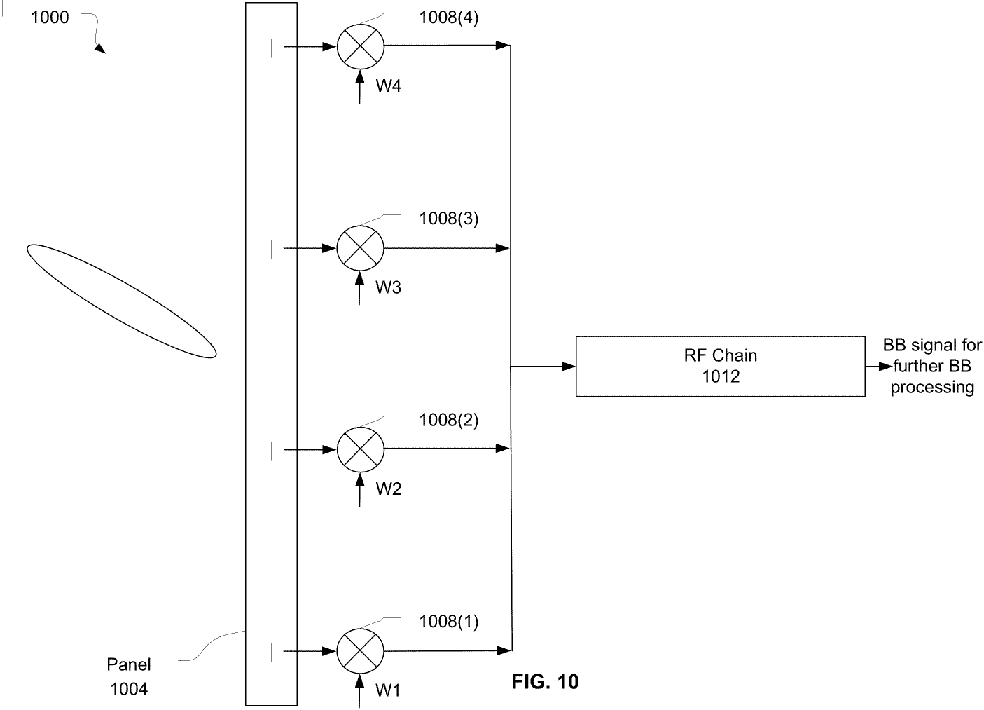

FIG. 10 illustrates receive components 1000 of the UE 104, in accordance with some embodiments. The receive components 1000 may include an antenna panel 1004 that includes a number of antenna elements. The panel 1004 is shown with four antenna elements, but other embodiments may include other numbers.

The antenna panel 1004 may be coupled to analog beamforming (BF) components that include a number of phase shifters 1008(1)-1008(4). The phase shifters 1008(1)-1008(4) may be coupled with a radio-frequency (RF) chain 1012. The RF chain 1012 may amplify a receive analog RF signal, down-convert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1008(1)-1008(4) to provide a receive beam at the antenna panel 1004. These BF weights may be determined based on the channel-based beamforming.

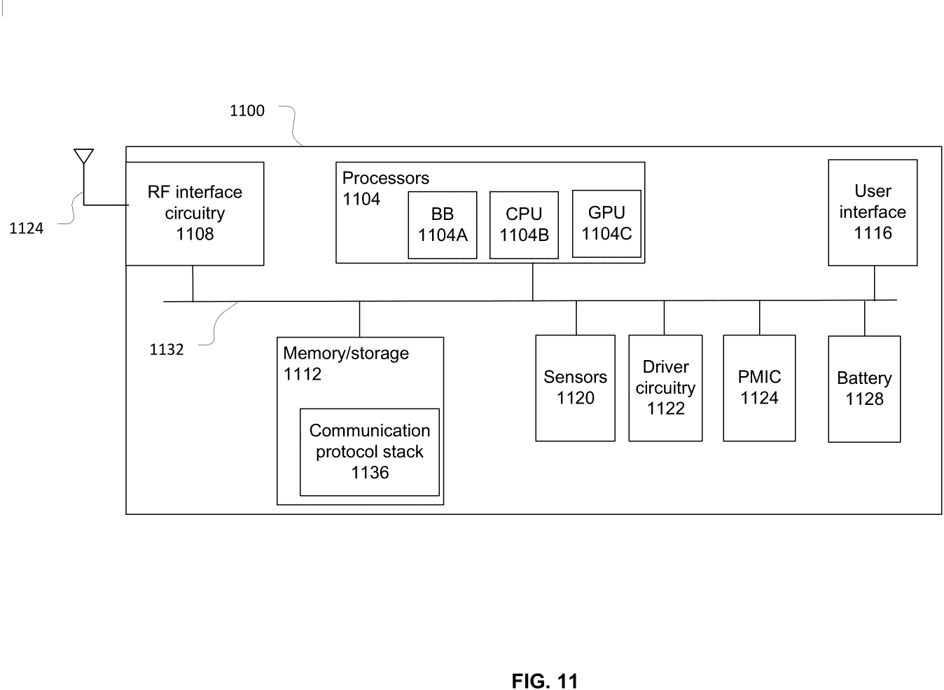

FIG. 11 illustrates a UE 1100, in accordance with some embodiments. The UE 1100 may be similar to and substantially interchangeable with UE 104 of FIG. 1.

Similar to that described above with respect to UE 104, the UE 1100 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1100 may include processors 1104, RF interface circuitry 1108, memory/storage 1112, user interface 1116, sensors 1120, driver circuitry 1122, power management integrated circuit (PMIC) 1124, and battery 1128. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangements of the components shown may occur in other implementations.

The components of the UE 1100 may be coupled with various other components over one or more interconnects 1132, which may represent any type of interface, input/output, bus (local, system, or expansion), transmission line, trace, optical connection, etc. that allows various circuit components (on common or different chips or chipsets) to interact with one another.

The processors 1104 may include processor circuitry, such as baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1112 to cause the UE 1100 to perform operations as described herein.

In some embodiments, the baseband processor circuitry 1104A may access a communication protocol stack 1136 in the memory/storage 1112 to communicate over a 3GPP compatible network. In general, the baseband processor circuitry 1104A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/altematively be performed by the components of the RF interface circuitry 1108.

The baseband processor circuitry 1104A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1104A may also access group information 1124 from memory/storage 1112 to determine search space groups in which a number of repetitions of a PDCCH may be transmitted.

The memory/storage 1112 may include any type of volatile or non-volatile memory that may be distributed throughout the UE 1100. In some embodiments, some of the memory/storage 1112 may be located on the processors 1104 themselves (for example, L1 and L2 cache), while other memory/storage 1112 is external to the processors 1104 but accessible thereto via a memory interface. The memory/storage 1112 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1108 may include transceiver circuitry and a radio frequency front module (RFEM) that allows the UE 1100 to communicate with other devices over a radio access network. The RF interface circuitry 1108 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1124 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1124.

In various embodiments, the RF interface circuitry 1108 may be configured to transmit/receive signals in a manner compatible with NR access technologies.

The antenna 1124 may include a number of antenna elements that each convert electrical signals into radio waves to travel through the air and to convert received radio waves into electrical signals. The antenna elements may be arranged into one or more antenna panels. The antenna 1124 may have antenna panels that are omnidirectional, directional, or a combination thereof to enable beamforming and multiple input, multiple output communications. The antenna 1124 may include microstrip antennas, printed antennas fabricated on the surface of one or more printed circuit boards, patch antennas, phased array antennas, etc. The antenna 1124 may have one or more panels designed for specific frequency bands including bands in FR1 or FR2.

The user interface circuitry 1116 includes various input/output (I/O) devices designed to enable user interaction with the UE 1100. The user interface 1116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1100.

The sensors 1120 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1122 may include software and hardware elements that operate to control particular devices that are embedded in the UE 1100, attached to the UE 1100, or otherwise communicatively coupled with the UE 1100. The driver circuitry 1122 may include individual drivers allowing other components to interact with or control various input/output (I/O) devices that may be present within, or connected to, the UE 1100. For example, driver circuitry 1122 may include a display driver to control and allow access to a display device, a touchscreen driver to control and allow access to a touchscreen interface, sensor drivers to obtain sensor readings of sensor circuitry 1120 and control and allow access to sensor circuitry 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the UE 1100. In particular, with respect to the processors 1104, the PMIC 1124 may control power-source selection, voltage scaling, battery charging, or DC-to-DC conversion.

In some embodiments, the PMIC 1124 may control, or otherwise be part of, various power saving mechanisms of the UE 1100. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1100 may power down for brief intervals of time and thus save power. If there is no data traffic activity for an extended period of time, then the UE 1100 may transition off to an RRC_Idle state, where it disconnects from the network and does not perform operations, such as channel quality feedback, handover, etc. The UE 1100 goes into a very low power state and it performs paging where again it periodically wakes up to listen to the network and then powers down again. The UE 1100 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1128 may power the UE 1100, although in some examples the UE 1100 may be mounted deployed in a fixed location and may have a power supply coupled to an electrical grid. The battery 1128 may be a lithium-ion battery, a metal-air battery, such as a zinc-air battery, an aluminum-air battery, a lithium-air battery, and the like. In some implementations, such as in vehicle-based applications, the battery 1128 may be a typical lead-acid automotive battery.

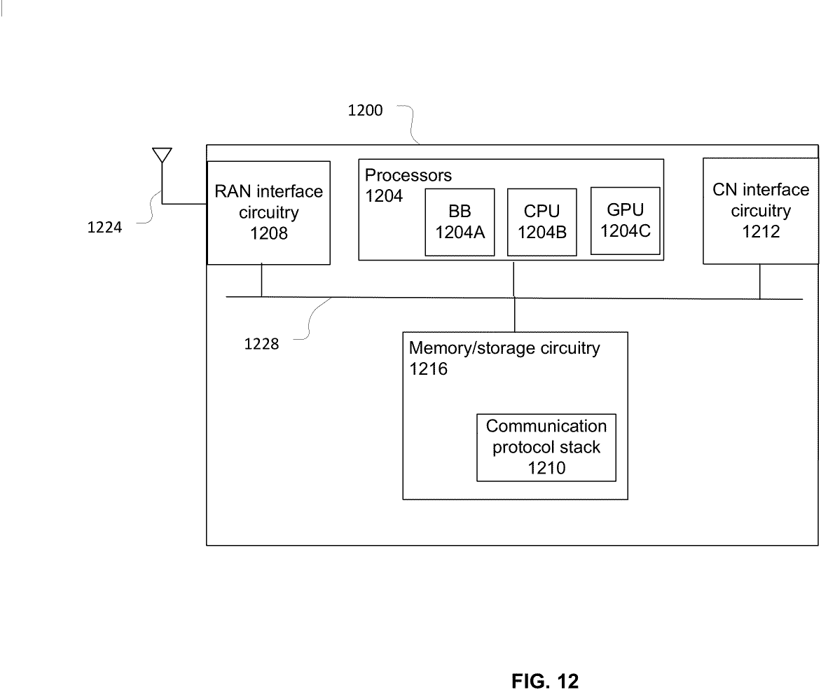

FIG. 12 illustrates a gNB 1200, in accordance with some embodiments. The gNB node 1200 may be similar to and substantially interchangeable with the gNB 108 of FIG. 1.

The gNB 1200 may include processors 1204, RF interface circuitry 1208, core network (CN) interface circuitry 1212, and memory/storage circuitry 1216.

The components of the gNB 1200 may be coupled with various other components over one or more interconnects 1228.

The processors 1204, RF interface circuitry 1208, memory/storage circuitry 1216 (including communication protocol stack 1210), antenna 1224, and interconnects 1228 may be similar to like-named elements shown and described with respect to FIG. 10.

The CN interface circuitry 1212 may provide connectivity to a core network, for example, a Fifth Generation Core (5GC) network using a 5GC-compatible network interface protocol, such as carrier Ethernet protocols, or some other suitable protocol. Network connectivity may be provided to/from the gNB 1200 via a fiber optic or wireless backhaul. The CN interface circuitry 1212 may include one or more dedicated processors or FPGAs to communicate using one or more of the aforementioned protocols. In some implementations, the CN interface circuitry 1212 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method implemented by a user equipment (UE), the method comprising: sending capability information to a network, the capability information indicating that the UE supports concurrent measurement gaps for an intra-radio access technology (RAT) measurement, the capability information further indicating whether the UE supports the concurrent measurement gaps for an inter-RAT measurement; receiving, from the network based on sending the capability information, configuration information indicating a configuration for the concurrent measurement gaps; determining, based on the configuration information, a measurement gap pattern; and performing a measurement on a reference signal sent based on the measurement gap pattern.

Example 2 includes the method of example 1, wherein the capability information is sent by using a first RAT, and wherein the capability information indicates, for a plurality of RATs other than the first RAT, that the UE supports more than one measurement gap configuration for the inter-RAT measurement.

Example 3 includes the method of example 2, wherein the capability information includes an index that is associated with the plurality of RATs and that indicates the UE’s support of the more than one gap configuration.

Example 4 includes the method of example 1, wherein the capability information is sent by using a first RAT, wherein the capability information indicates, per RAT of a plurality of RATs other than the first RAT, that the UE supports more than one measurement gap configuration for the inter-RAT measurement.

Example 5 includes the method of example 4, wherein the capability information includes a plurality of indices, wherein each index corresponds to one of the plurality of RATs and indicates the UE’s support of the more than one gap configuration in association with the one of the plurality of RATs.

Example 6 includes the method of example 1, wherein the capability information is sent by using a first RAT, wherein the capability information indicates, for a plurality of RATs other than the first RAT, that the UE supports a number of concurrent measurement gap patterns for the inter-RAT measurement.

Example 7 includes the method of example 6, wherein the capability information includes a measurement gap parameter having a value equal to the number of concurrent measurement gap patterns.

Example 8 includes the method of example 1, wherein the capability information is sent by using a first RAT, wherein the capability information indicates, per RAT of a plurality of RATs other than the first RAT, that the UE supports a number of concurrent measurement gap patterns for the inter-RAT measurement.

Example 9 includes the method of example 8, wherein the capability information includes, per RAT of the plurality of RATs, a measurement gap parameter having a value equal to the number of concurrent measurement gap patterns supported by the UE for the RAT.

Example 10 includes the method of any examples 1-9, wherein the capability information is sent by using a first RAT, wherein the configuration is not supported by the UE for the first RAT and not a second RAT and indicates that, for the second RAT, a first measurement object is associated with a first measurement gap pattern and that a second measurement object is associated with a second measurement gap pattern, and wherein the method further comprises: selecting the first measurement gap pattern for use in association with the second RAT; and performing, based on the first measurement gap pattern, a first measurement on a first reference signal and a second measurement on a second reference signal, wherein the first reference signal corresponds to the first measurement object, and wherein the second reference signal corresponds to the second measurement object.

Example 11 includes the method of any examples 1-9, wherein the capability information is sent by using a first RAT, wherein the configuration is not supported by the UE for the first RAT and not a second RAT and indicates that, for the second RAT, a first measurement object is associated with a first measurement gap pattern and that a second measurement object is associated with a second measurement gap pattern, and wherein the method further comprises: selecting the first measurement gap pattern for use in association with the second RAT; and performing, based on the first measurement gap pattern, a first measurement on a first reference signal that corresponds to the first measurement object, and wherein the second measurement object is ignored by the UE.

Example 12 includes the method of example 1, wherein the capability information is sent by using a first RAT, wherein the capability information indicates that the UE supports the concurrent measurement gaps for a second RAT separately from the UE’s support of the concurrent measurement gaps for the first RAT, and wherein the configuration indicates a first measurement gap pattern to be used in association with the first RAT and a second measurement gap pattern to be used in association with the second RAT.

Example 13 includes a method implemented by a base station, the method comprising: receiving a first capability information from a user equipment (UE), the capability information indicating that the UE supports concurrent measurement gaps for an intra-radio access technology (RAT) measurement, the capability information further indicating whether the UE supports the concurrent measurement gaps for an inter-RAT measurement; sending, to the UE, based on the capability information, configuration information indicating a configuration for the concurrent measurement gaps; and sending, based on the configuration, a reference signal to be measured during a measurement gap.

Example 14 includes the method of example 13, wherein the capability information is received by using a first RAT, wherein the capability information indicates that the UE supports the concurrent measurement gaps for a second RAT, and wherein the configuration indicates a first measurement gap pattern to be used in association with the first RAT and a second measurement gap pattern to be used in association with the second RAT.

Example 15 includes the method of example 13, wherein the capability information is received by using a first RAT, wherein the capability information indicates that the UE does not support the concurrent measurement gaps for a second RAT, and wherein the configuration indicates a first measurement gap pattern to be used in association with the first RAT only.

Example 16 includes the method of example 13, wherein the capability information is received by using a first RAT, wherein the capability information indicates, for a plurality of RATs other than the first RAT, that the UE supports more than one measurement gap configuration for the inter-RAT measurement, and wherein the configuration indicates a measurement gap pattern to be used in association with the plurality of RATs.

Example 17 includes the method of example 13, wherein the capability information is received by using a first RAT, wherein the capability information indicates, per RAT of a plurality of RATs other than the first RAT, that the UE supports more than one measurement gap configuration for the inter-RAT measurement, and wherein the configuration indicates, per RAT of the plurality of RATs, a measurement gap pattern to be used in association with the RAT.

Example 18 includes the method of example 13, wherein the capability information is received by using a first RAT, wherein the capability information indicates, for a plurality of RATs other than the first RAT, that the UE supports a number of concurrent measurement gap patterns for the inter-RAT measurement, and wherein the configuration indicates, based on the number, one or more measurement gap patterns to be used in association with the plurality of RATs.

Example 19 includes the method of example 13, wherein the capability information is received by using a first RAT, wherein the capability information indicates, per RAT of a plurality of RATs other than the first RAT, that the UE supports a number of concurrent measurement gap patterns for the inter-RAT measurement, and wherein the configuration indicates, per RAT of the plurality of RAT and based on the number corresponding to the RAT, one or more measurement gap patterns to be used in association with the RAT.

Example 20 includes a UE comprising means to perform one or more elements of a method described in or related to any of the examples 1-12.

Example 21 includes one or more non-transitory computer-readable media comprising instructions to cause a UE, upon execution of the instructions by one or more processors of the UE, to perform one or more elements of a method described in or related to any of the examples 1-12.

Example 22 includes a UE comprising logic, modules, or circuitry to perform one or more elements of a method described in or related to any of the examples 1-12.

Example 23 includes a UE comprising: one or more processors and one or more computer-readable media comprising instructions that, when executed by the one or more processors, cause the one or more processors to perform one or more elements of a method described in or related to any of the examples 1-12.

Example 24 includes a system comprising means to perform one or more elements of a method described in or related to any of the examples 1-12.

Example 25 includes a network comprising means to perform one or more elements of a method described in or related to any of the examples 13-19.

Example 26 includes one or more non-transitory computer-readable media comprising instructions to cause a network, upon execution of the instructions by one or more processors of the network, to perform one or more elements of a method described in or related to any of the examples 13-19.

Example 27 includes a network comprising logic, modules, or circuitry to perform one or more elements of a method described in or related to any of the examples 13-19.

Example 28 includes a network comprising: one or more processors and one or more computer-readable media comprising instructions that, when executed by the one or more processors, cause the one or more processors to perform one or more elements of a method described in or related to any of the examples 13-19.

Example 29 includes a system comprising means to perform one or more elements of a method described in or related to any of the examples 1-19.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

Applicant hereby claims:

1. A user equipment (UE) comprising:
one or more processors; and
one or more memory storing computer-readable instructions that, upon execution by the one or more processors, configure the UE to:
send capability information to a network, the capability information indicating that the UE supports concurrent measurement gaps for an intra-radio access technology (RAT) measurement, the capability information further indicating whether the UE supports the concurrent measurement gaps for an inter-RAT measurement;
receive, from the network based on sending the capability information, configuration information indicating a configuration for the concurrent measurement gaps;
determine, based on the configuration information, a measurement gap pattern; and
perform a measurement on a reference signal sent based on the measurement gap pattern.

2. The UE of claim 1, wherein the capability information is sent by using a first RAT, and wherein the capability information indicates, for a plurality of RATs other than the first RAT, that the UE supports more than one measurement gap configuration for the inter-RAT measurement.

3. The UE of claim 2, wherein the capability information includes an index that is associated with the plurality of RATs and that indicates the UE’s support of the more than one gap configuration.

4. The UE of claim 1, wherein the capability information is sent by using a first RAT, wherein the capability information indicates, per RAT of a plurality of RATs other than the first RAT, that the UE supports more than one measurement gap configuration for the inter-RAT measurement.

5. The UE of claim 4, wherein the capability information includes a plurality of indices, wherein each index corresponds to one of the plurality of RATs and indicates the UE’s support of the more than one gap configuration in association with the one of the plurality of RATs.

6. The UE of claim 1, wherein the capability information is sent by using a first RAT, wherein the capability information indicates, for a plurality of RATs other than the first RAT, that the UE supports a number of concurrent measurement gap patterns for the inter-RAT measurement.

7. The UE of claim 6, wherein the capability information includes a measurement gap parameter having a value equal to the number of concurrent measurement gap patterns.

8. The UE of claim 1, wherein the capability information is sent by using a first RAT, wherein the capability information indicates, per RAT of a plurality of RATs other than the first RAT, that the UE supports a number of concurrent measurement gap patterns for the inter-RAT measurement.

9. The UE of claim 8, wherein the capability information includes, per RAT of the plurality of RATs, a measurement gap parameter having a value equal to the number of concurrent measurement gap patterns supported by the UE for the RAT.

10. The UE of claim 1, wherein the capability information is sent by using a first RAT, wherein the configuration is not supported by the UE for the first RAT and not a second RAT and indicates that, for the second RAT, a first measurement object is associated with a first measurement gap pattern and that a second measurement object is associated with a second measurement gap pattern, and wherein the execution of the computer-readable instructions further configures the UE to:
select the first measurement gap pattern for use in association with the second RAT;
perform, based on the first measurement gap pattern, a first measurement on a first reference signal and a second measurement on a second reference signal, wherein the first reference signal corresponds to the first measurement object, and wherein the second reference signal corresponds to the second measurement object.

11. The UE of claim 1, wherein the capability information is sent by using a first RAT, wherein the configuration is not supported by the UE for the first RAT and not a second RAT and indicates that, for the second RAT, a first measurement object is associated with a first measurement gap pattern and that a second measurement object is associated with a second measurement gap pattern, and wherein the execution of the computer-readable instructions further configures the UE to:
select the first measurement gap pattern for use in association with the second RAT;
perform, based on the first measurement gap pattern, a first measurement on a first reference signal that corresponds to the first measurement object, and wherein the second measurement object is ignored by the UE.

12. A method implemented by a base station, the method comprising:
receiving a first capability information from a user equipment (UE), the capability information indicating that the UE supports concurrent measurement gaps for an intra-radio access technology (RAT) measurement, the capability information further indicating whether the UE supports the concurrent measurement gaps for an inter-RAT measurement;
sending, to the UE, based on the capability information, configuration information indicating a configuration for the concurrent measurement gaps; and
sending, based on the configuration, a reference signal to be measured during a measurement gap.

13. The method of claim 12, wherein the capability information is received by using a first RAT, wherein the capability information indicates that the UE supports the concurrent measurement gaps for a second RAT, and wherein the configuration indicates a first measurement gap pattern to be used in association with the first RAT and a second measurement gap pattern to be used in association with the second RAT.

14. The method of claim 12, wherein the capability information is received by using a first RAT, wherein the capability information indicates that the UE does not support the concurrent measurement gaps for a second RAT, and wherein the configuration indicates a first measurement gap pattern to be used in association with the first RAT only.

15. The method of claim 12, wherein the capability information is received by using a first RAT, wherein the capability information indicates, for a plurality of RATs other than the first RAT, that the UE supports more than one measurement gap configuration for the inter-RAT measurement, and wherein the configuration indicates a measurement gap pattern to be used in association with the plurality of RATs.

16. The method of claim 12, wherein the capability information is received by using a first RAT, wherein the capability information indicates, per RAT of a plurality of RATs other than the first RAT, that the UE supports more than one measurement gap configuration for the inter-RAT measurement, and wherein the configuration indicates, per RAT of the plurality of RATs, a measurement gap pattern to be used in association with the RAT.

17. The method of claim 12, wherein the capability information is received by using a first RAT, wherein the capability information indicates, for a plurality of RATs other than the first RAT, that the UE supports a number of concurrent measurement gap patterns for the inter-RAT measurement, and wherein the configuration indicates, based on the number, one or more measurement gap patterns to be used in association with the plurality of RATs.

18. The method of claim 12, wherein the capability information is received by using a first RAT, wherein the capability information indicates, per RAT of a plurality of RATs other than the first RAT, that the UE supports a number of concurrent measurement gap patterns for the inter-RAT measurement, and wherein the configuration indicates, per RAT of the plurality of RAT and based on the number corresponding to the RAT, one or more measurement gap patterns to be used in association with the RAT.

19. One or more computer-readable storage media storing instructions that, upon execution on a user equipment (UE), cause the UE to perform operations comprising:
sending capability information to a network, the capability information indicating that the UE supports concurrent measurement gaps for an intra-radio access technology (RAT) measurement, the capability information further indicating whether the UE supports the concurrent measurement gaps for an inter-RAT measurement;
receiving, from the network based on sending the capability information, configuration information indicating a configuration for the concurrent measurement gaps;
determining, based on the configuration information, a measurement gap pattern; and
performing a measurement on a reference signal sent based on the measurement gap pattern.

20. The one or more computer-readable storage media of claim 19, wherein the capability information is sent by using a first RAT, wherein the capability information indicates that the UE supports the concurrent measurement gaps for a second RAT separately from the UE’s support of the concurrent measurement gaps for the first RAT, and wherein the configuration indicates a first measurement gap pattern to be used in association with the first RAT and a second measurement gap pattern to be used in association with the second RAT.
